(19) United States
(12) Patent Application Publication
(10) Pub. No.: US 2013/0246538 A1
(43) Pub. Date: Sep. 19, 2013

(54) Delivering Notification in an Internal Network

(71) Applicants: Amit Maimon, Tel Aviv (IL); Nati Ari, Zoran (IL)

(72) Inventors: Amit Maimon, Tel Aviv (IL); Nati Ari, Zoran (IL)

(73) Assignee: SAP AG, Walldorf (DE)

(21) Appl. No.: 13/418,610

(22) Filed: Mar. 13, 2012

(51) Int. Cl. G06F 15/16

(52) U.S. Cl. 709/206

(57) ABSTRACT

A computer-implemented method for delivering notifications in an internal network of an organization includes: receiving, at a notifications server in the internal network and from a user, an electronic message formulated using a message format; reading, by the notifications server, a setting of an importance parameter for the electronic message; determining one or more proper recipients for the electronic message, wherein if the importance parameter has a first setting the proper recipients are all users of the internal network regardless of addressee specification, and if the importance parameter has a second setting the proper recipients are determined by the addressee specification; and sending, by the notifications server, a notification having a markup-language format to the proper recipients for presentation in a client, wherein the client has no function for responding to the notification.

### BACKGROUND

People who use computers on a daily basis, particularly in a professional setting such as at the workplace, sometimes face the situation that they are receiving more emails than they can meaningfully deal with on a daily basis. This can particularly be a problem in large organizations that have installed notifications, or other reminders or alerts, to be automatically generated and sent via an email system to a larger or smaller group of employees.

Sometimes, the decision of who will receive these automatic notifications is not made by each recipient individually, but rather is controlled from a central position, such as by the project management or an administrator. This can create the situation where employees of the organization find themselves asking various notification senders to remove that employee from an old distribution list so that the employee will no longer receive irrelevant updates, etc.

### SUMMARY

In a first aspect, a computer-implemented method for delivering notifications in an internal network of an organization includes: receiving, at a notifications server in the internal network and from a user, an electronic message formulated using a message format; reading, by the notifications server, a setting of an importance parameter for the electronic message; determining one or more proper recipients for the electronic message, wherein if the importance parameter has a first setting the proper recipients are all users of the internal network regardless of addressee specification, and if the importance parameter has a second setting the proper recipients are determined by the addressee specification; and sending, by the notifications server, a notification having a markup-language format to the proper recipients for presentation in a client, wherein the client has no function for responding to the notification.

In a second aspect, a computer program product is tangibly embodied in a computer-readable storage medium and includes instructions that when executed by a processor perform a method for delivering content in an internal network of an organization. The method includes: receiving, at a notifications server in the internal network and from a user, an electronic message formulated using a message format; reading, by the notifications server, a setting of an importance parameter for the electronic message; determining one or more proper recipients for the electronic message, wherein if the importance parameter has a first setting the proper recipients are all users of the internal network regardless of addressee specification, and if the importance parameter has a second setting the proper recipients are determined by the addressee specification; and sending, by the notifications server, a notification having a markup-language format to the proper recipients for presentation in a client, wherein the client has no function for responding to the notification.

In a third aspect, a system includes: one or more processors; and a computer program product tangibly embodied in a computer-readable storage medium and comprising instructions that when executed by the one or more processors perform a method for delivering content in an internal network of an organization. The method includes: receiving, at a notifications server in the internal network and from a user, an electronic message formulated using a message format; reading, by the notifications server, a setting of an importance parameter for the electronic message; determining one or more proper recipients for the electronic message, wherein if the importance parameter has a first setting the proper recipients are all users of the internal network regardless of addressee specification, and if the importance parameter has a second setting the proper recipients are determined by the addressee specification; and sending, by the notifications server, a notification having a markup-language format to the proper recipients for presentation in a client, wherein the client has no function for responding to the notification.

Implementations can include any or all of the following features. The method further includes receiving respective self-registrations from multiple users regarding a topic, and wherein the addressee specification specifies only the topic. The user generates the electronic message using an email program that is also configured to generate emails for transmission to users in the internal network and others, and the notification is presented to the proper recipients without using the email program. The notification is presented to the proper recipients as a popup on a computer desktop. The user attaches a file or other object as an attachment to the electronic message, and the file or other object is presented to the proper recipients. The electronic message relates to a topic, and the method further includes specifying, before sending the notification, that only the user is authorized to send messages for that topic using the notifications server.

Implementations can provide any or all of the following advantages. An easier and quicker way for receiving and sending instant alerts to specific groups of participants can be provided. Messages can be caused to pop up silently on the users' desktops, insuring that whoever actually wants that particular notification also receives it. A fallback for system failure in an exchange server can be provided. The need for “do not reply” emails can be reduced or eliminated by directing such messages to another communication channel.

The details of one or more implementations are set forth in the accompanying drawings and the description below. Other features and advantages will be apparent from the description and drawings, and from the claims.

### DESCRIPTION OF DRAWINGS

FIG. 1 shows an example of a system that can perform internal notification.

FIG. 2 shows an example of a process for internal notification.

FIG. 3 shows an example of a user's desktop.

FIG. 4 shows an example of a registration view.

FIG. 5 shows an example of an alerts view.

FIG. 6 shows an example of a notification window.

FIG. 7 shows an example of initiating a message from an email program.

FIG. 8 shows an example of a message object.

FIG. 9 is a block diagram of a computing system that can be used in connection with computer-implemented methods described in this document.

Like reference symbols in the various drawings indicate like elements.

### DETAILED DESCRIPTION

This document describes examples of self-managed internal notification systems that can be used in an internal network by a large or small organization. For example, users in the organization can register for the notification topics that are relevant to their work, or that are otherwise of interest to the individual user, and can thereby reduce the amounts of unwanted or irrelevant automatic notifications that they receive. The notifications do not provide for the recipients to respond to the delivered message, which can further reduce the amounts of notifications.

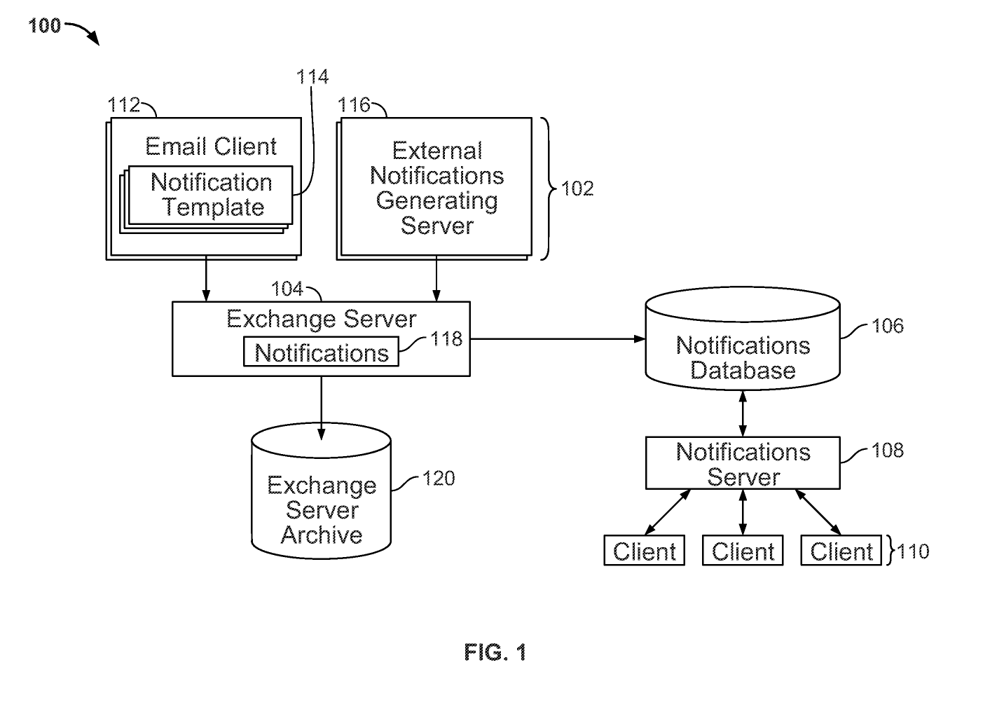

FIG. 1 shows an example of a system 100 that can perform internal notification. The system 100 can be implemented in, or as, an internal computer network for one or more organizations, for example in form of an intranet that uses internet protocol (IP) addresses to communicate with individual network nodes. The system 100 includes one or more sending-level components 102 that can generate an electronic message, at least one exchange server 104 for receiving and processing the message before distribution, one or more notifications databases 106 where electronic messages and/or their contents can be stored before delivery, at least one notifications server 108 that can determine proper recipients, among other things, and clients 110 that can present notifications generated from the component(s) 102 depending on the user's particular registration(s) to receive alerts.

The sending-level components 102 can include one or more email client programs 112. For example, a Microsoft Outlook program or any other standalone email client can be used as the program 112. While the program 112 serves as an editor of electronic messages, the messages are not emails, but rather are sent as internal notifications without the recipient being able to respond to the notification. In some implementations, a message editor other than an email client can be used instead of, or together with, the program 112. The email client program 112 (or other program) can used one or more notification templates 114 that can, for example, provide formatting, topic specification, attachment functionality, and editing function(s) for creating the electronic message. Any type of notification(s) can be generated including, but not limited to, team updates, status reports, general announcements, or personal messages, to name a few examples.

The sending-level components 102 can include one or more external notifications generating servers 116. In some implementations, an application programming interface (API) of the server(s) 116 can facilitate that notifications are automatically generated for particular topics. For example, the server 116 can provide a rule-based alert system that sends notifications at predefined times or when certain conditions occur. Any type of notification(s) can be generated including, but not limited to, automatic build messages (e.g., build reports for a particular project), status messages, and system alerts.

The exchange server 104 is configured to receive the generated electronic messages from one or more of the sending-level components 102. The electronic message has a message format when generated. In some implementations, the message is formatted according to Simple Mail Transfer Protocol (SMTP). For example, one or more of the sending-level components 102 can be configured so that it generates the message directly in SMTP format, and/or an intermediate message format can be used that the exchange server converts or transforms to the SMTP format. In some implementations, the exchange server 104 has a notifications add-on component 118 that allows the exchange server to recognize and handle the notifications in a special way, separate from, say, how the exchange server handles email messages generated by the email client 114 or other non-notifications.

The notifications database 106 can use any suitable database technology. In some implementations, the exchange server 104 inserts notification details for each new message into the database substantially when the message is received. For example, notification details can include or specify notification contents (e.g., text and/or graphics), any notification attachments (e.g., a file or other object), a message topic and an expiration date. In some implementations, the expiration date is not directly specified in the message or the notification, but rather is determined using one or more rules. The expiration date can depend on the topic, message importance, recipients, time of day, and/or message length, to name just a few examples.

The notifications server 108 can obtain new notifications from the notifications database 106 per topic an expiration date. In some implementations, any notifications that have not yet been sent are forwarded to the notifications server (e.g., by a push process) whenever available or at regular or irregular intervals. In some implementations, the notifications server accesses the database 106 from time to time to check for new notifications to be delivered.

The notifications server 108 converts the notification to a format that is suitable for one or more of the clients 110. One or more markup languages can be used. The message can have SMTP format when created and the notifications server can then generate a notification having a markup-language format. For example, the notifications server 108 generates the message using Hypertext Markup Language (HTML) 4.x code. That is, even when the email client 114 is used to generate the notification, the recipients will receive and access the notification in some other way than using an email client.

The clients 110 can provide notification presentation in one or more suitable ways. For example, the notification(s) can pop up on the desktop of the proper user(s) and remain visible (or otherwise active) until the user clears the notification or it reaches its expiration time (if any). The clients 110 can be implemented using any suitable technology including, but not limited to, a desktop notification area application, an add-on or plug-in to a browser or other viewer program, or as a plug-in to an integrated development environment (IDE).

In some implementations, one or more of the clients 110 is compatible with Hypertext Transfer Protocol (HTTP). For example, an HTTP-compatible program can be executed under an operating system running on the corresponding user device. In some implementations, one or more of the clients 110 can request new notifications (e.g., by a pull process) from the notifications server 108 at regular or irregular intervals.

The system 100 can provide archiving of electronic messages in one or more ways. In some implementations, the exchange server 104 has an exchange server archive 120 where electronic messages can be stored for a shorter or longer time. For example, SMPT auditing can be used so that audit trails or logs of SMTP messages are available.

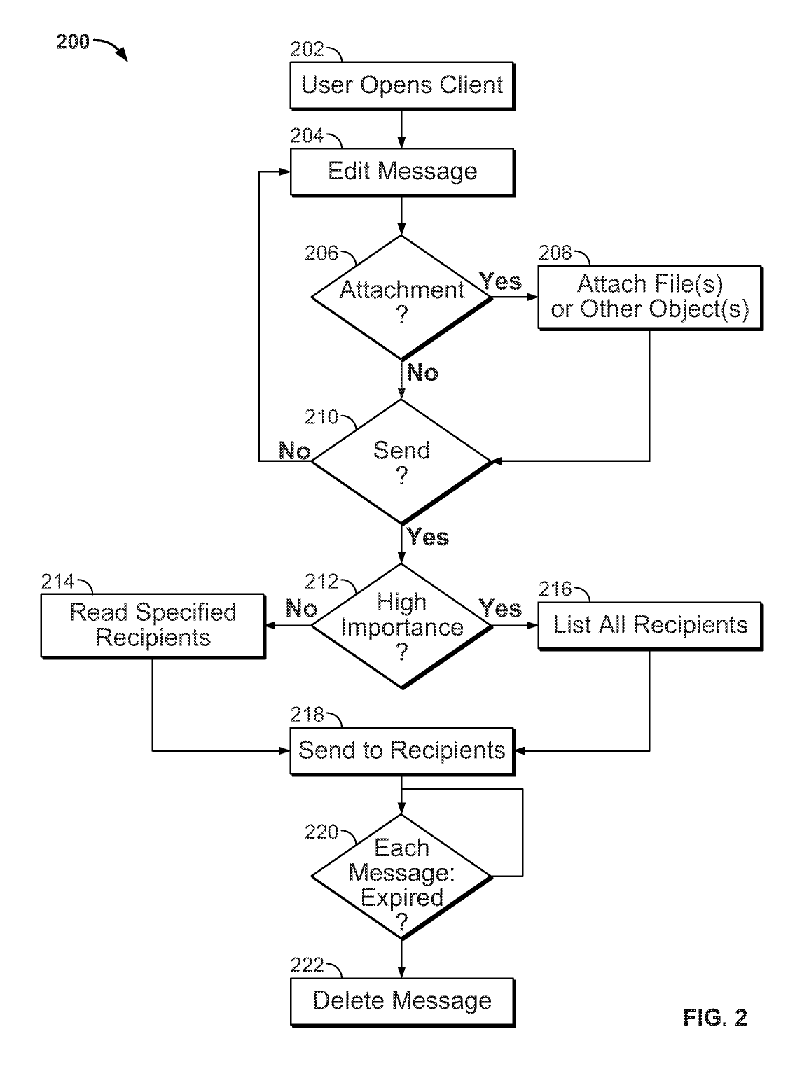

FIG. 2 shows an example of a process 200 for internal notification. The process can be implemented for processor-based execution in any suitable system, for example in the system 100 (FIG. 1). This example assumes that the user who is sending the message, and one or more other users who are the potential recipients of the notification, have previously registered (e.g., with a notification server) so that they are recognized in the system as such.

At 202, a user opens a client for generating the notification. For example, the user can open any of the sending-level components 102 (FIG. 1). A particular example of an email program interface will be described later. At 204, the user edits the message. For example, one or more of the notification templates 114 can be the starting point for message creation and the user can then add text, graphics and/or any other content to generate the particular message for this situation. The message is essentially not limited to any particular size or formatting. For example, a virtually unlimited amount of text or other content can be included, subject only to external limitations that may be imposed by the operating system and/or server functionality. At 206 the method checks whether the user is attaching anything to the message, and if so, one or more files and/or other objects are attached to the message at 208. At 210, the method checks whether the message is ready to send (e.g., whether the user is finished with the editing and/or attaching steps), and if not, the method can return, for example to message editing at 204.

If the message is ready to be sent at 210, then a determination is made at 212 whether the message has been assigned one or more particular importance values. For example, the user can label the message “important” depending on its contents or topic. In some implementations, multiple levels of importance (or other criterion) can be used. Such levels can include, but are not limited to, any of regular, important, high importance, info, receipt confirmation requested, to name just a few examples.

If the message has not been labeled as high importance, or whatever labeling threshold is applied (or if the message has no importance label), then the specified recipients are read at 214. In some implementations, the recipients can be specified in the electronic message or they can be determined based on the message topic. For example, all users who have registered to receive notification regarding a particular ongoing project, or regarding items for sale that are unrelated to work, can be deemed the specified recipients depending on the message. The recipient identities can be specified in any suitable way, such as by their IP addresses or using any other identifier.

In contrast, if the message is found to have high importance at 212 (e.g., because the message was flagged or otherwise labeled with a particular indicator), then it can be sent to all users regardless of registration. For that purpose, all recipients can be listed at 216. In some implementations, all users who have access to the internal network are deemed the intended recipients when the message is labeled with a particular importance indicator. For example, this can ensure that sufficiently important messages are sent to all users whether they have registered for notifications or not.

Whether only the specified recipients are deemed the proper recipients (i.e., at 214), or whether the message should go to all recipients (i.e., at 216), the notification is sent to the proper recipients at 218. For example, the IP addresses of the proper recipients can be used, and an HTML notification can be sent to the clients 110 (FIG. 1) of the proper recipients.

In some implementations, the inclusion of all recipients at 216 can override one or more user-specified values. For example, even if the message topic is normally assigned to only a limited group of registered users, this setting can be overridden by the importance flagging. As another example, even if the message explicitly specifies one or more recipients, the notification can be distributed to all users based on its importance.

At 220, it can be determined for each message or notification whether it has expired. This can be done locally at the device of the individual recipient. For example, a desktop notification area application on a personal computer or handheld device can determine, for one or more notifications, whether the notification has expired. If the expiration time has not been reached, the method can return to an earlier stage. If the expiration time has been reached at 220, the message or other notification can be deleted at 222.

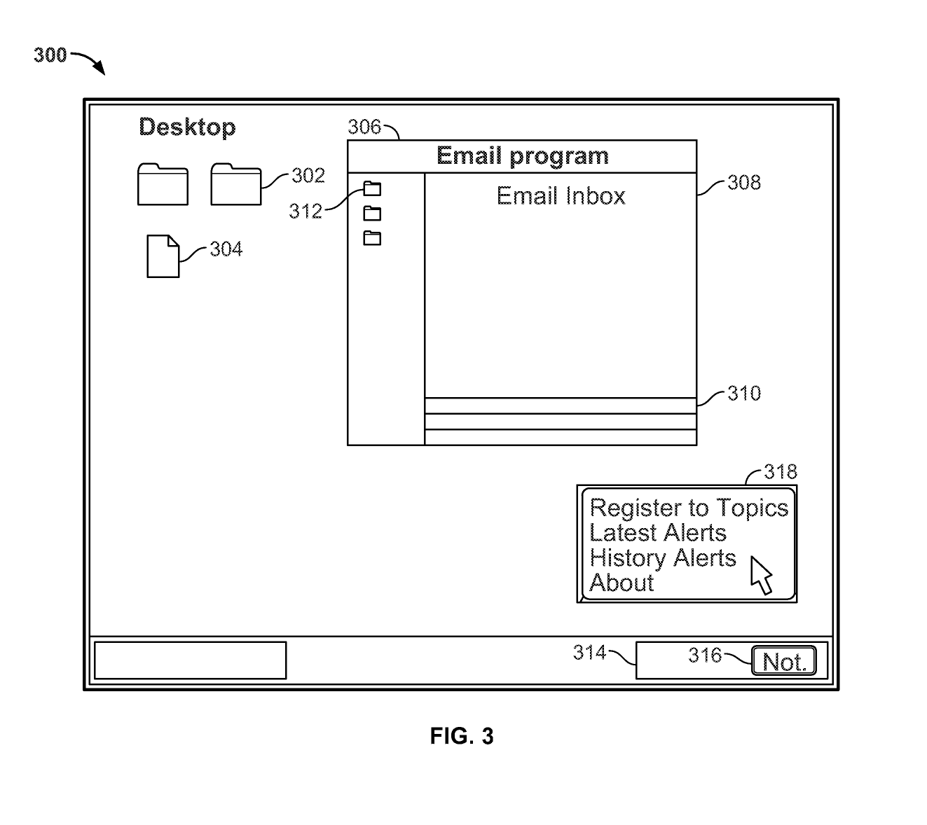

FIG. 3 shows an example of a user's desktop 300. The desktop 300 can have included therein one or more folders 302 for files or other objects, one or more files 304, and one or more running application programs, here an email program 306. The email program is currently open and the user can therefore see and interact with an email inbox 308, one or more individual emails 310 or one or more folders 312 for emails, calendar items or contacts, to name just a few examples.

The desktop 300 can include one or more toolbars 314. In some implementations, the toolbar 314 can include buttons, icons or other controls corresponding to functions, services or components provided by an operating system in which the desktop is running. Here, the toolbar 314 includes a notification button 316 that when clicked (or otherwise activated) by the user causes a notifications menu 318 to be presented. The notifications menu can be presented in any suitable way including, but not limited to, as a pop-up or other window or pane on the desktop 300.

The notifications menu 318 allows the user to perform one or more actions relating to notifications. For example, the user can register to one or more topics, view the latest alert(s), view a history of received alerts, and/or learn more about the notification system.

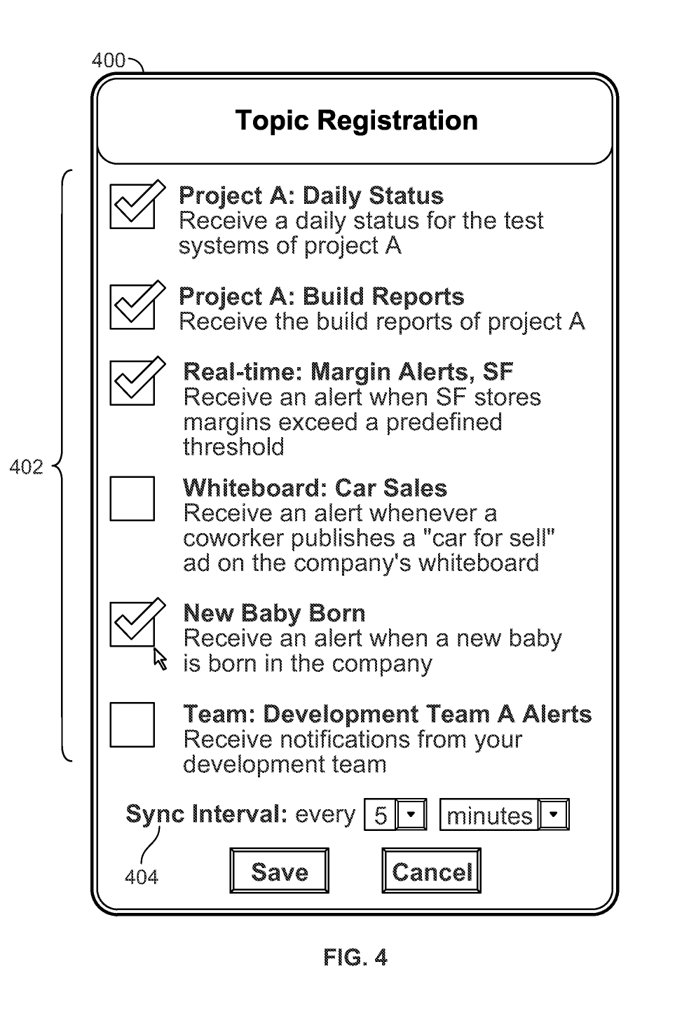

FIG. 4 shows an example of a registration view 400. In some implementations, the registration view can be presented in response to user selection of a topic registration control (e.g., in the notifications menu 318 in FIG. 3). The registration view can present one or more available topics 402 to the user so that the user can perform self-registration for topics that are relevant. The available topics can be an exhaustive list of all notification topics in the internal computer network for which user registration is possible. As another example, the available topics 402 can be a filtered or otherwise reduced list that is tailored to the user in one or more ways, such as by user role.

Here, the particular available topics 402 are for illustrative purposes only. The examples include, but are not limited to, a daily status for a project; build reports for a project, margin alerts for one or more stores, a whiteboard function (e.g., for selling or buying personal property), personal announcements, and team alerts. Notifications can be generated for any topic.

The user indicates one or more of the available topics 402 as being of interest by a checkmark in the corresponding box. For example, this user has currently registered for notifications regarding daily project status, the project build reports, the store margin alerts, and the personal announcements, but not for the whiteboard function or for the team alerts. If the user is no longer interested in one or more registrations, they can be unregistered in the corresponding way. The registration view 400 also serves as a lookup where the user can see the topic(s) for which he or she is currently registered.

A control 404 lets the user specify how often the user's client should synchronize the delivery of notifications. For example, this setting can regulate when the user's client should pull notifications from the notifications server 108 (FIG. 1). The setting can be specified by a numerical value (in the current example, 5) and a unit of time (in the current example, minutes). Other ways of specifying when notifications should be requested or delivered can be used.

When the user is done, the changes in registrations can either be saved or canceled, and the registration view 400 can thereafter cease to be presented.

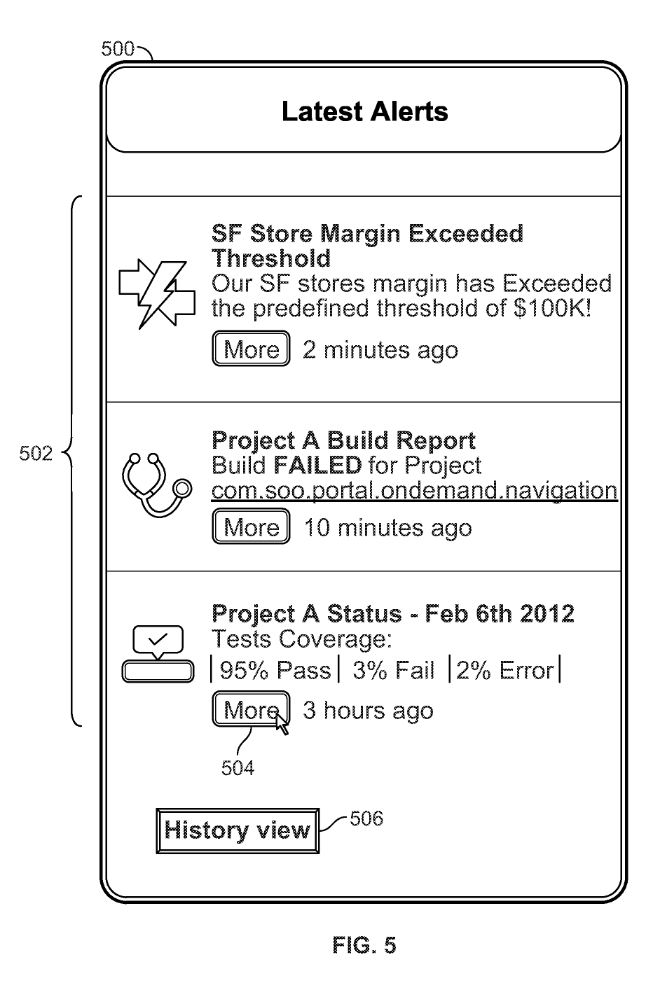

FIG. 5 shows an example of an alerts view 500. In some implementations, the alerts view can be presented in response to user selection of a latest alerts control (e.g., in the notifications menu 318 in FIG. 3). The alerts view can present one or more notifications 502 that are the most recent ones to have been received for this user. For example, the notifications 502 here relate to store margin alerts, build reports for a project, and a status for the same project. One advantage of the alerts view 500, or other similar views that show alerts, is that they can help reduce the amount of email traffic in the system. For example, notifications that would otherwise have been sent by email, with the instruction “do not reply” in the messages, can instead be directed to the alerts view 500, where there is no way for the recipient(s) to reply, and wherein the alert may simply disappear after a predetermined amount of time (or upon the occurrence of some event). This can reduce the volume of emails in user inboxes and eliminates the need for the user to delete such messages that are old or otherwise not relevant. Indeed, if the user does not look at the alerts view 500 for some amount of time, then upon the user's return only those alerts that continue to be relevant are presented. That is, alerts that arrived while the user was away but which expired before the employee returned will likely go unnoticed by this user. Also, the ability to choose among alert topics allows the user control over the incoming information flow.

Each notification entry can include some information about the underlying notification including, but not limited to, a title, a graphics object or other image, a brief description and a notification age (e.g., how long ago the notification was generated or delivered). Other information can be included. A more button 504 allows the user to access more details about any or all of the notifications. A history view button 506 allows the user to see a history view, which can for example list more notifications than the alerts view 500.

After being displayed, the alerts view 500 can disappear after a specified time, or when the user clicks outside the view (e.g., elsewhere on the desktop), or when the user clicks on any of the buttons 504 or 506, to name just a few examples.

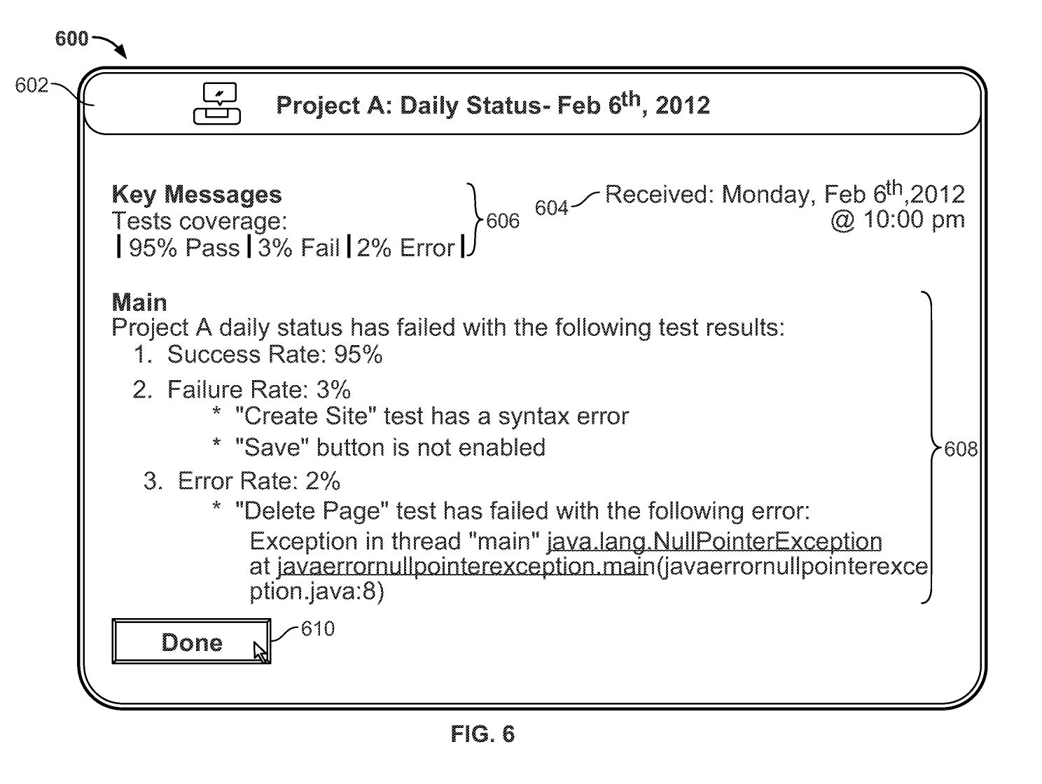

FIG. 6 shows an example of a notification window 600. In some implementations, the notification window can be presented in response to user selection of an individual notification (e.g., using the more button 504 in FIG. 5). Here, the user is being shown the daily status notification regarding “Project A”. The notification window 600 can include a header area 602, time/date information area 604, a key message area 606, a main message area 608 and a done button 610. For example, the information in the areas 602-608 may have been obtained from the notifications database 106 (FIG. 1) by a notifications server and assembled in HTML format for distribution to this particular user (and others). Upon selection of the done button 610, the notification window 600 can disappear. Also, in the latest alerts view 500 (FIG. 5), the entry regarding this notification may disappear or be omitted after the user is done with the notification.

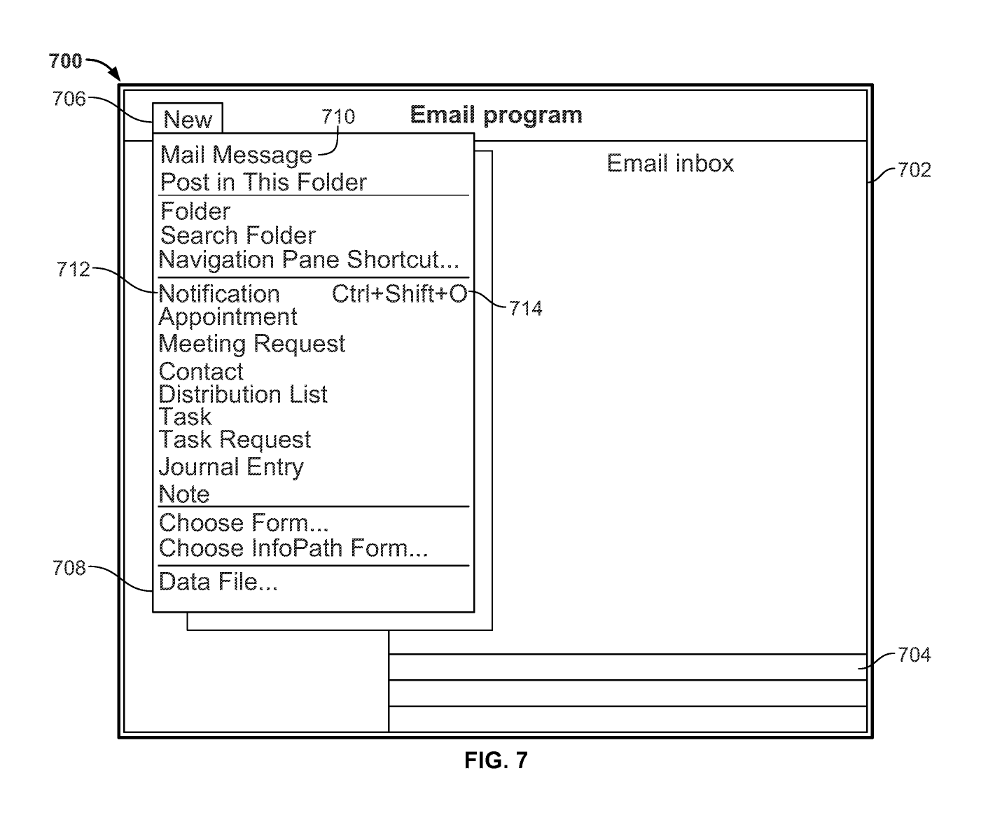

FIG. 7 shows an example of initiating a message from an email program 700. In some implementations, the email program 700 provides an email inbox 702 having individual emails 704 therein. Upon user selection of a new control 706, a menu 708 is presented. The menu 708 includes multiple commands or other controls 710 that are associated with particular objects or functions in the email program. In some implementations, the command 710 can allow the user to create a new email, meeting request or note, and the email program 700 will perform the required function(s) accordingly. For example, the user can create a new email, specify one or more recipients, type the email message, and send the email to the recipient(s), who will then be able to read the message in their email program (same or different) and respond or forward the email at will.

The menu 708 also includes a notification control 712. In contrast to emails, the user cannot respond to the notifications generated using the notification control 712. Also, the notifications may be presented in a place other than an email inbox (e.g., in a desktop notification area application), and may expire and vanish after some time. A shortcut control 714 allows the user to quickly open a new notification. That is, the above is an example of using an email program (e.g., Microsoft Outlook) as a client for creating notifications.

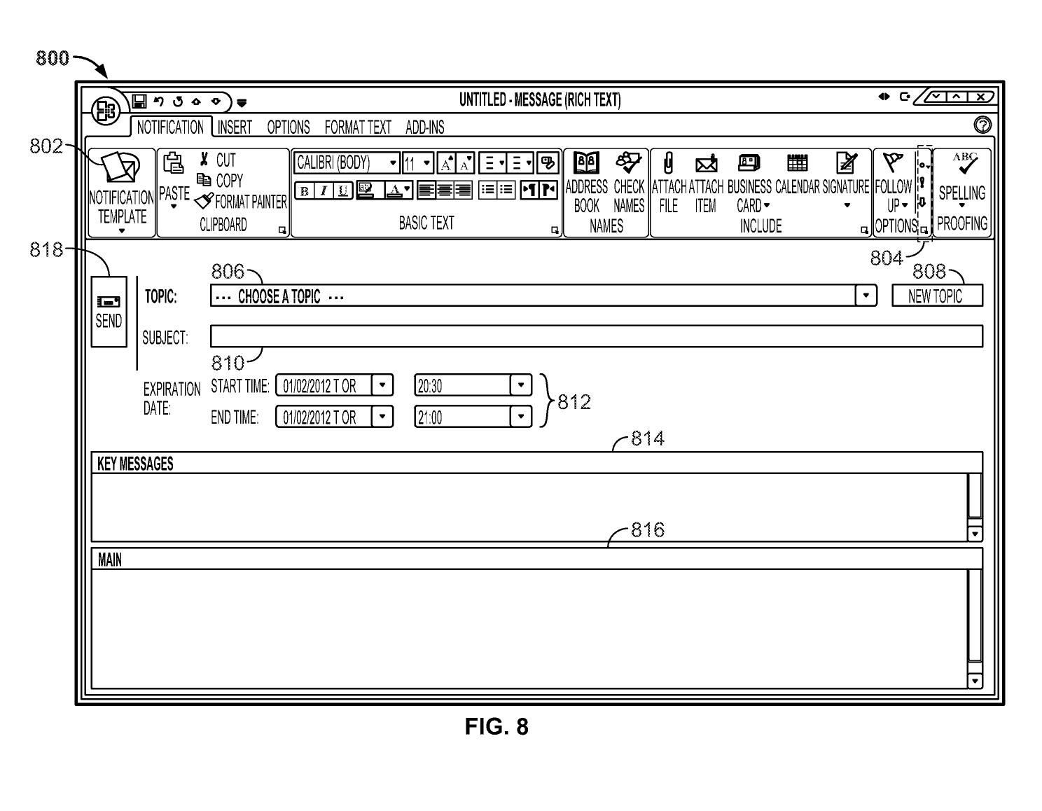

FIG. 8 shows an example of a message object 800. In some examples, the message object 800 is generated by activating the notification control 712 (FIG. 7) to create a new notification. A template control 802 can be used to choose between one or more notification templates for the new notification. A value setting control 804 allows the user to flag or otherwise label the notification. For example, the notification can be specified as having high importance. A topic control 804 allows the user to specify a topic for the notification. For example, the user can type the topic using a keyboard, or can select from a list (not shown) of existing topics. A new topic control 808 allows the user to specify a new topic. In some situations, the user who creates a topic can be defined to be the only one authorized to send the corresponding notifications. In other situations (e.g., to use notification as a whiteboard for the employees), a created topic can be made available for any registered user to send notifications. However, the notification system does not allow responses to the notifications.

The user types a subject for the notification using a control 810 and can set an expiration date using a control 812. For example, the user can specify that the notification should be sent at a start time and should expire (i.e., users should no longer be notified) at an end time. That is, if one of the recipients looks at his or her current notifications (e.g., using the alerts view 500 in FIG. 5) between the start and end times, the notification being created here will appear in that view. In contrast, if another one of the recipients does not look at his or her current notifications until after the specified end time, the notification will not be shown in that recipient's view. In some implementations, if such a user views a history of alerts (e.g., using the history view button 506 in FIG. 5) the expired notification can appear in that context despite having expired before being observed by this user.

A key message area 814 allows the user to compose one or more key messages for the notification. For example, the key message can summarize the most important aspects of the notification (e.g., those that are shown in the alerts view 500 in FIG. 5).

A main message area 816 allows the user to enter more detailed information for the notification. For example, this information can describe a current project status or specify an item or service for sale. The areas 814 and 816 can hold amounts of information that are for practical purposes essentially unlimited. For example, large volumes of text and/or large image objects can be included in the notification, such as by embedding. In some implementations, the user can attach one or more separate files or other objects to the notification.

A send control 818 allows the user to send the notification when ready. In some implementations, the sending causes an electronic message (e.g., having SMTP format) to be generated and sent to an exchange server, where it can also optionally be archived. The exchange server can then store message details in a notifications database, from where they can be retrieved by a notifications server that send the notification to the proper recipients.

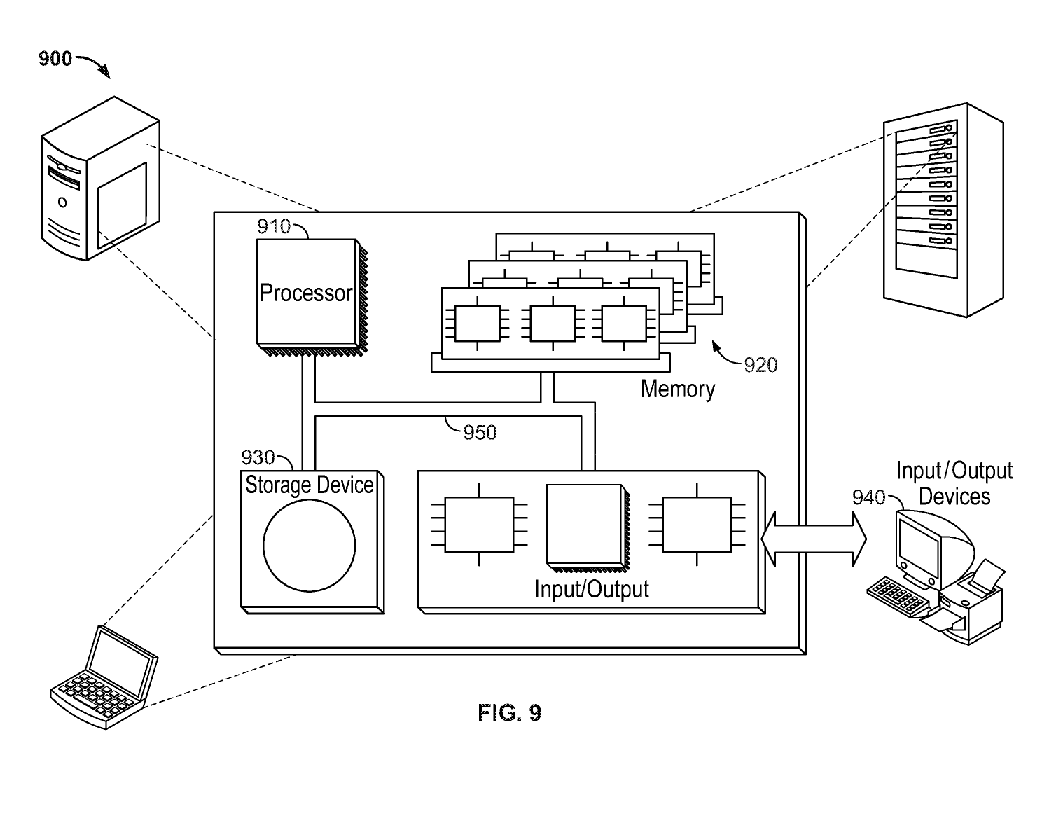

FIG. 9 is a schematic diagram of a generic computer system 900. The system 900 can be used for the operations described in association with any of the computer-implement methods described previously, according to one implementation. The system 900 includes a processor 910, a memory 920, a storage device 930, and an input/output device 940. Each of the components 910, 920, 930, and 940 are interconnected using a system bus 950. The processor 910 is capable of processing instructions for execution within the system 900. In one implementation, the processor 910 is a single-threaded processor. In another implementation, the processor 910 is a multi-threaded processor. The processor 910 is capable of processing instructions stored in the memory 920 or on the storage device 930 to display graphical information for a user interface on the input/output device 940.

The memory 920 stores information within the system 900. In some implementations, the memory 920 is a computer-readable medium. The memory 920 is a volatile memory unit in some implementations and is a non-volatile memory unit in other implementations.

The storage device 930 is capable of providing mass storage for the system 900. In one implementation, the storage device 930 is a computer-readable medium. In various different implementations, the storage device 930 may be a floppy disk device, a hard disk device, an optical disk device, or a tape device.

The input/output device 940 provides input/output operations for the system 900. In one implementation, the input/output device 940 includes a keyboard and/or pointing device. In another implementation, the input/output device 940 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of this disclosure. Accordingly, other implementations are within the scope of the following claims.

What is claimed is:

1. A computer-implemented method for delivering notifications in an internal network of an organization, the method comprising:
receiving, at a notifications server in the internal network and from a user, an electronic message formulated using a message format;
reading, by the notifications server, a setting of an importance parameter for the electronic message;
determining one or more proper recipients for the electronic message, wherein if the importance parameter has a first setting the proper recipients are all users of the internal network regardless of addressee specification, and if the importance parameter has a second setting the proper recipients are determined by the addressee specification; and
sending, by the notifications server, a notification having a markup-language format to the proper recipients for presentation in a client, wherein the client has no function for responding to the notification.

2. The computer-implemented method of claim 1, further comprising receiving respective self-registrations from multiple users regarding a topic, and wherein the addressee specification specifies only the topic.

3. The computer-implemented method of claim 1, wherein the user generates the electronic message using an email program that is also configured to generate emails for transmission to users in the internal network and others, and wherein the notification is presented to the proper recipients without using the email program.

4. The computer-implemented method of claim 1, wherein the notification is presented to the proper recipients as a popup on a computer desktop.

5. The computer-implemented method of claim 1, wherein the user attaches a file or other object as an attachment to the electronic message, and wherein the file or other object is presented to the proper recipients.

6. The computer-implemented method of claim 1, wherein the electronic message relates to a topic, the method further comprising specifying, before sending the notification, that only the user is authorized to send messages for that topic using the notifications server.

7. A computer program product tangibly embodied in a computer-readable storage medium and comprising instructions that when executed by a processor perform a method for delivering content in an internal network of an organization, the method comprising:
receiving, at a notifications server in the internal network and from a user, an electronic message formulated using a message format;
reading, by the notifications server, a setting of an importance parameter for the electronic message;
determining one or more proper recipients for the electronic message, wherein if the importance parameter has a first setting the proper recipients are all users of the internal network regardless of addressee specification, and if the importance parameter has a second setting the proper recipients are determined by the addressee specification; and
sending, by the notifications server, a notification having a markup-language format to the proper recipients for presentation in a client, wherein the client has no function for responding to the notification.

8. The computer program product of claim 7, the method further comprising receiving respective self-registrations from multiple users regarding a topic, and wherein the addressee specification specifies only the topic.

9. The computer program product of claim 7, wherein the user generates the electronic message using an email program that is also configured to generate emails for transmission to users in the internal network and others, and wherein the notification is presented to the proper recipients without using the email program.

10. The computer program product of claim 7, wherein the notification is presented to the proper recipients as a popup on a computer desktop.

11. The computer program product of claim 7, wherein the user attaches a file or other object as an attachment to the electronic message, and wherein the file or other object is presented to the proper recipients.

12. The computer program product of claim 7, wherein the electronic message relates to a topic, the method further comprising specifying, before sending the notification, that only the user is authorized to send messages for that topic using the notifications server.

13. A system comprising:
one or more processors; and
a computer program product tangibly embodied in a computer-readable storage medium and comprising instructions that when executed by the one or more processors perform a method for delivering content in an internal network of an organization, the method comprising:
receiving, at a notifications server in the internal network and from a user, an electronic message formulated using a message format;
reading, by the notifications server, a setting of an importance parameter for the electronic message;
determining one or more proper recipients for the electronic message, wherein if the importance parameter has a first setting the proper recipients are all users of the internal network regardless of addressee specification, and if the importance parameter has a second setting the proper recipients are determined by the addressee specification; and
sending, by the notifications server, a notification having a markup-language format to the proper recipients for presentation in a client, wherein the client has no function for responding to the notification.

14. The system of claim 13, the method further comprising receiving respective self-registrations from multiple users regarding a topic, and wherein the addressee specification specifies only the topic.

15. The system of claim 13, wherein the user generates the electronic message using an email program that is also configured to generate emails for transmission to users in the internal network and others, and wherein the notification is presented to the proper recipients without using the email program.

16. The system of claim 13, wherein the notification is presented to the proper recipients as a popup on a computer desktop.

17. The system of claim 13, wherein the user attaches a file or other object as an attachment to the electronic message, and wherein the file or other object is presented to the proper recipients.

18. The system of claim 13, wherein the electronic message relates to a topic, the method further comprising specifying, before sending the notification, that only the user is authorized to send messages for that topic using the notifications server.
